(19) United States
(12) Patent Application Publication
(10) Pub. No.: US 2014/0354768 A1
(43) Pub. Date: Dec. 4, 2014

(54) Socialized Mobile Photography

(71) Applicant: Microsoft Corporation, Redmond, WA (US)

(72) Inventors: Tao Mei, Beijing (CN); Shipeng Li, Palo Alto, CA (US); Wenyuan Yin, Buffalo, NY (US); Chang Wen Chen, East Amherst, NY (US)

(21) Appl. No.: 13/905,347

(22) Filed: May 30, 2013

(51) Int. Cl. G06T 7/00; H04N 5/232

(52) U.S. Cl. CPC G06T 7/0022; H04N 5/23216; H04N 5/23238
USPC 348/36; 348/222.1

(57) ABSTRACT

A system, method or computer readable storage device to enable mobile devices in capturing high quality photos by using both the rich context available from mobile devices and crowd-sourced social media on the Web. Considering the flexible and adaptive adoption of photography principles with different content and context composition rules and exposure principles are learned from the community-contributed images. Leveraging a mobile device user's scene context and social context, the proposed socialized mobile photography system is able to suggest optimal view enclosure to achieve appealing composition. Due to the complex scene content and a number of shooting-related contexts to exposure parameters, exposure learning is applied to suggest appropriate camera parameters.

### BACKGROUND

The recent popularity of mobile devices and the rapid development of wireless network technologies have revolutionized the way people take and share multimedia content. With the pervasiveness of mobile devices, more and more people are taking photos to share their experiences using their mobile devices.

### SUMMARY

The mobile devices equipped with various cameras provide a platform for taking photos. Described herein are techniques for assisting a mobile device user in capturing high quality photos by using both context available from the mobile devices and crowd-sourced social media on the Web. In various embodiments, a photography model is learned from community-contributed images on the Web, and the context. The context includes for example geo-location, time (e.g., time of the day), and weather (e.g., clear, cloudy, foggy, etc). By being provided with a wide view of scene, the appropriate view enclosure (e.g., composition) and camera parameters (e.g., aperture, ISO, and exposure time) may be determined. Therefore, proper composition and camera parameters to help the user capture high quality photos may be suggested.

In various embodiments, the mobile devices or any remotely located computing device may include one or more of an input image module, a suggestion receiving module, an offline photography learning module and an online photography module.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an overview of an example scheme of socialized mobile photography, in accordance with various embodiments.

FIG. 2 illustrates example computing devices for socialized mobile photography, in accordance with various embodiments.

FIG. 3 is a flow diagram of an example process for socialized mobile photography, in accordance with various embodiments.

FIG. 4 is a flow diagram of an example process for exposure parameter suggestion, in accordance with various embodiments.

FIG. 5 is a flow diagram of an example process for exposure parameter adjustment, in accordance with various embodiments.

### DETAILED DESCRIPTION

### Overview

Although mobile device cameras harness a variety of technologies to take care of many camera settings (e.g., auto-exposure) for point-and-shoot ease, capturing high quality photos is a challenging task for amateur mobile users lacking photography knowledge and experience. Therefore, assisting amateur mobile users to capture high quality photos via their mobile devices is desirable. For example, scene composition and suitable camera settings (e.g., exposure parameters such as aperture, ISO, and exposure time (ET)) may be suggested to the user based on the user's current context (e.g., geo-location, time-of-day, and weather condition) and input scene.

This disclosure describes, in part, a method, system or computer-readable storage device to assist mobile users in capturing high quality photos by suggesting view enclosure with optimal composition and setting correct exposure parameters. As used herein, “mobile device” refers to any device that a user may utilize to take a photograph. For example, the mobile device may be a cellular phone, tablet computer, or a point-and-shoot camera. An “image” refers to data or information of the scene that may be captured by the mobile device. For example, the image may be a graphical picture displayed on the mobile device. The image may also be parameter information utilized by the mobile device or another computer. The image maybe a picture or a photograph. Also, “photography” refers to the practice of creating durable images by recording light or other electromagnetic radiation.

In various embodiments, a socialized mobile photography system leverages both the context and crowd-sourced photography knowledge to aid mobile users in acquiring high-quality photos. The system may suggest one or more view enclosures with optimal composition by mining the scene specific composition rules from the crowd-sourced community-contributed photos. The system may recommend exposure parameters given the suggested composition and the lighting condition. The system may provide a user interface of a built-in application that naturally guides users to capture images through the mobile device.

In various embodiments, given the input image and the shooting context, e.g., geo-location, time, and weather, view enclosures may be suggested with the desired composition with exposure parameters, e.g., ISO, aperture, and exposure time (ET), by mining exposure rules from the crowd-sourced images with similar content and context.

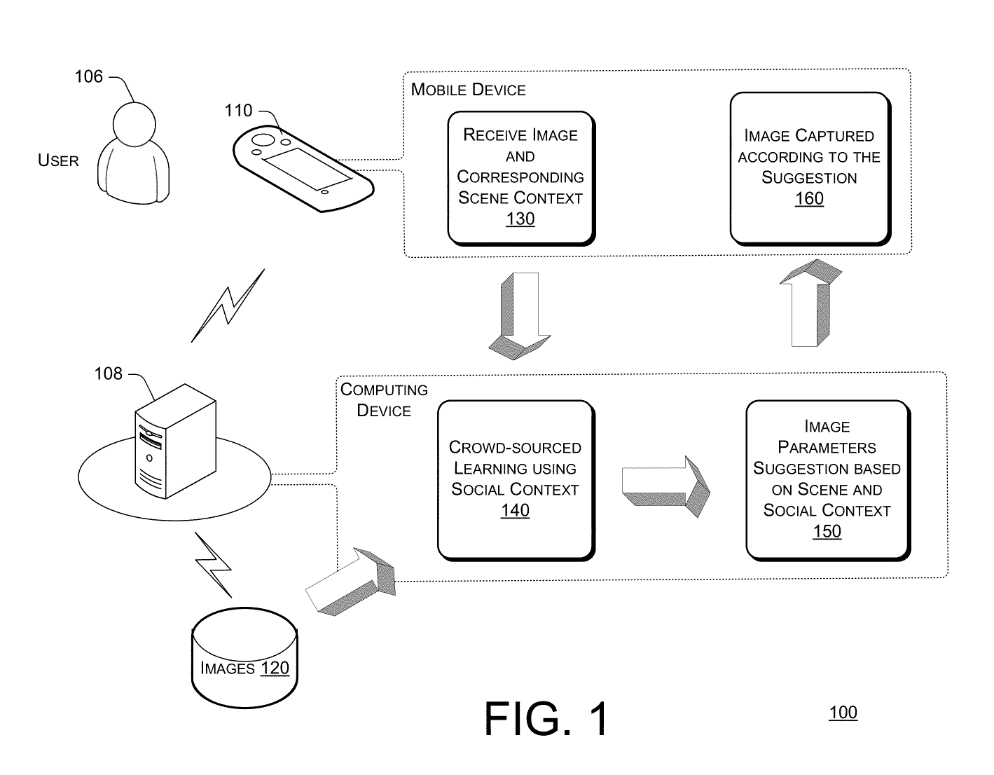

FIG. 1 shows an overview of an example scheme of socialized mobile photography, in accordance with various embodiments. As illustrated in FIG. 1, the scheme of social mobile photography 100 may facilitate taking of high quality photography by a user 106 using a mobile device 110 in conjunction with crowd-sourced social media on the web such as a computing device 108, which may be located in the cloud. In some embodiments, the mobile device 110 may receive an image and corresponding scene context 130. The image and the corresponding scene context 130 are then uploaded to a remote server, computing device 108 or the cloud. Crowd-sourced learning 140 is performed using social context. The social context includes crowd-sourced images 120 and/or corresponding information. Image parameters 150 may be determined based on the scene and social context. The parameters may be suggested, and the image using the parameters may be captured 160.

In various embodiments, the scheme of social mobile photography 100 may use the social context of the crowd-sourced images 120. Crowd-sourced learning 140 may be performed using context parameters from the mobile device 110 such as the GPS, time of day, or any images and corresponding scene context 130. Other photography related context information, e.g., weather condition at the shooting time, may be further inferred. The crowd-sourced images 120, which may be on social media websites or other remote locations, may be associated with metadata info, e.g., GPS, timestamp, exchangeable image file format (EXIF), and camera parameters. In some embodiments, crowd-sourced learning 140 may be performed by inferring the photo quality using the scene context and aggregating the crowd-sourced images 120. For example, from the images of the social media website, photo quality may be inferred from statistics (e.g., number of views, number of favorites, and comments) or explicitly obtained from ratings. Despite some noise in the metadata, by aggregating the images containing the same scene with their metadata from the media website, the aggregated images may provide significant insight into relevant photography rules in terms of composition and exposure parameters for mobile photography assistance. The image parameters suggestion 150 may suggest the optimal view and parameters based on discovered photography rules by performing a view cluster discovering followed by a view specific composition learning and exposure parameter learning scheme. These parameters may be used by the mobile device such that the image may be captured 160 so that the captured image may be similar to pictures taken by expert or professional photographers.

For example, when capturing an input image on a mobile device, using the content and context of the input image, images with the similar content from similar perspectives with associated social information that can reflect their qualities may be crowd-sourced. By analyzing the composition and the aesthetic quality of these crowd-sourced images, an altered composition of the input image may be inferred. Moreover, utilizing the input time and weather condition, camera exposure parameters may be estimated from the crowd-sourced photos with similar content and lighting conditions.

### Example Electronic Device

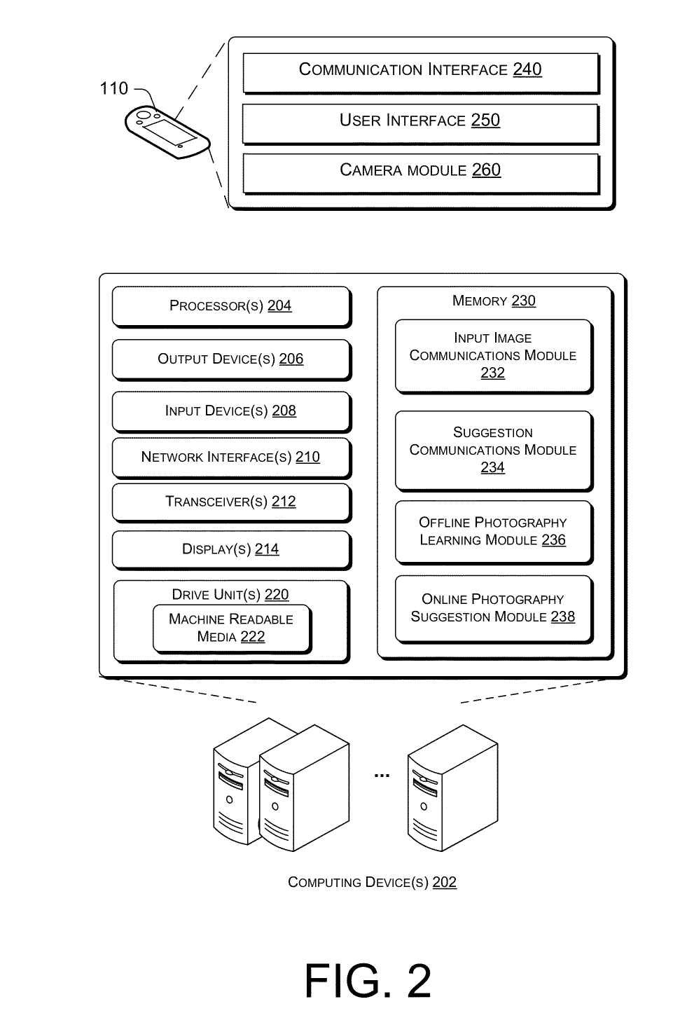

FIG. 2 illustrates an example computing device configured to assist mobile users in capturing high quality photos by using both the context available from mobile devices and crowd-sourced social media via the web. As illustrated, one or more computing device(s) 202 (referred to as “computing device 108”) may include processor(s) 204, output device(s) 206, input device(s) 208, network interface(s) 210, transceiver(s) 212, display(s) 214, drive unit(s) 220, and memory 230. The drive unit(s) 220 may include one or more machine readable media 222.

In various embodiments, the computing device(s) 202 may be any sort of computing device or computing devices. For example, the computing device(s) 202 may be or include a personal computer (PC), a laptop computer, a server or server farm, a mainframe, a tablet computer, a work station, a telecommunication device, a personal digital assistant (PDA), a media player, a media center device, a personal video recorder (PVR), a television, or any other sort of device or devices. In one implementation, the computing device(s) 202 represents a plurality of computing devices working in communication, such as a cloud computing network of nodes. When implemented on multiple computing devices (e.g., in a cloud computing system, etc.), the computing device(s) 202 may distribute the modules and data among the multiple devices. In some implementations, the computing device(s) 202 represents one or more virtual machines implemented on one or more computing devices.

In some implementations, a network may connect multiple devices represented by the computing device(s) 202, as mentioned above. Also, such network may connect the computing device(s) 202 to other devices. The network may be any type or combination of network, such as a data center network, a wide area network (WAN), a local area network (LAN), or the Internet. Also, the network may be public, private, or include both public and private networks. Further, the network may be wired, wireless, or include both wired and wireless networks. The network may utilize any one or more protocols for communication, such as the Internet Protocol (IP), other packet based protocols, carrier sense multiple access with collision avoidance (CSMA/CA), or any other protocols. Additionally, the network may include any number of intermediary devices, such as routers, switches, base stations, access points, firewalls, or gateway devices. Any of these devices or other devices with similar functions may be used as the intermediate nodes.

In various embodiments, processor(s) 204 may include any one or more processors, central processing units, graphic processing units, or any other sort of processing unit.

In some embodiments, the output device(s) 206 include any sort of output devices known in the art, such as a display (described below as display 214), speakers, a vibrating mechanism, or a tactile feedback mechanism. Output device(s) 206 also may include ports for one or more peripheral devices, such as headphones, peripheral speakers, or a peripheral display.

In various embodiments, input device(s) 208 include any sort of input devices known in the art. For example, input devices 208 may include a microphone, a camera, a keyboard/keypad, or a touch-sensitive display (such as the touch-sensitive display screen described above). A microphone may accept voice commands as input. A camera may capture an image or gesture as input. A keyboard/keypad may be a multi-key keyboard (such as a conventional QWERTY keyboard) or one or more other types of keys or buttons, and may also include a joystick-like controller and/or designated navigation buttons, or the like.

In various embodiments, the network interface(s) 210 may be any sort of interfaces. The network interface(s) 210 may support both wired and wireless connections to networks, such as cellular networks, radio, Wi-Fi networks, and short range networks (e.g., Bluetooth, IR, and so forth). Network interface(s) 210 may include any one or more of a WAN interface or a LAN interface.

In some embodiments, the transceiver(s) 212 include any sort of transceivers known in the art. The transceiver(s) 212 may include a radio interface. The transceiver(s) 212 may facilitate wired or wireless connectivity between the computing device(s) 202 and other devices.

In various embodiments, the display(s) 214 may include the display device and may be a LCD, plasma display panel (PDP), light-emitting diode (LED) display, or a cathode ray tube (CRT) display. Display(s) 214 may also be a touch-sensitive display screen, and can then also act as an input device or keypad, such as for providing a soft-key keyboard, navigation buttons, or the like.

The machine readable media 222 may be located in drive unit(s) 220 to store one or more sets of instructions (e.g., software) embodying any one or more of the methodologies or functions described herein. The instructions may also reside, completely or at least partially, within the memory 230 and within the processor(s) 204 during execution thereof by the computing device(s) 202. The memory 230 and the processor(s) 204 also may constitute the machine readable media 222.

Depending on the exact configuration and type of the computing device(s) 202, the memory 230 may be volatile (such as RAM), non-volatile (such as ROM, flash memory, miniature hard drive, memory card, or the like) or some combination thereof. The memory 230 may include an operating system, one or more program modules, and program data.

The computing device(s) 202 may have additional features and/or functionality. For example, the computing device(s) 202 may also include additional data storage devices (removable and/or non-removable) such as, for example, magnetic disks, optical disks, or tape. Such additional storage may include removable storage and/or non-removable storage.

As used herein, machine readable media 222 may include, at least, two types of Machine readable media, namely computer storage media and communication media.

Computer storage media may include volatile and non-volatile, removable, and non-removable media implemented in any method or technology for storage of information, such as computer readable instructions, data structures, program modules, or other data. The memory 230, the removable storage and the non-removable storage are all examples of computer storage media. Computer storage media includes, but is not limited to, random access memory (RAM), read only memory (ROM), electronically erasable programmable ROM (EEPROM), flash memory or other memory technology, compact disk ROM (CD-ROM), digital versatile disks (DVD), or other optical storage, magnetic cassettes, magnetic tape, magnetic disk storage or other magnetic storage devices, or any other medium that can be used to store information and which can be accessed by the computing device(s) 202. Any such computer storage media may be part of the computing device(s) 202. Moreover, the machine readable media 222 may include computer-executable instructions that, when executed by the processor(s) 204, perform various functions and/or operations described herein.

In contrast, communication media may embody computer-readable instructions, data structures, program modules, or other data in a modulated data signal, such as a carrier wave. As defined herein, computer storage media does not include communication media.

In various embodiments, memory 230 (and other memories described throughout) is an example of computer-readable storage device and may include the volatile and nonvolatile memory. Thus, the memory 230 may include, but is not limited to, RAM, ROM, EEPROM, flash memory, or other memory technology, miniature hard drive, memory card, optical storage (e.g., CD-ROM, DVD), magnetic cassettes, magnetic tape, magnetic disk storage (e.g., floppy disk, hard drives, etc.) or other magnetic storage devices, or any other medium which can be used to store information, media items or applications and data for access by the computing device(s) 202.

Memory 230 may also be described as computer readable storage media and may include removable and non-removable media implemented in any method or technology for storage of information, such as computer readable instructions, data structures, program modules, or other data.

The memory 230 may be used to store any number of functional components that are executable on the processor(s) 204, as well as data and content items that are rendered by the computing device 202. Thus, the memory 230 may, for example, store an operating system. In various embodiments, an image input module 232, a suggestion receiving module 234, an offline photography learning module 236 and an online photography suggestion module 238 may be stored in the memory 230.

In various embodiments, the image input module 232 takes the to-be-taken wide-view image along with the context info of the mobile user as input and sends it to the online photography suggestion module 238. The input wide-view image may either be directly taken, or synthesized from multiple consecutive photos taken by the mobile user. In some embodiments, by utilizing the input image and its geo-location as well as the lighting condition related contexts such as time, date and weather condition, the online photography suggestion module 238 may suggest optimal view enclosures and proper exposure parameters for fitting the shooting content and context based on photography rules learned from crowd-sourced social media data and metadata which may be obtained from the Internet.

In various embodiments, suggestion receiving module 234 receives suggestions computed using the offline photography learning module 236 and online photography suggestion module 238 to aid mobile users in capturing images such that they appears to be more similar to professionally taken photographs. The suggestions include the view enclosure with professional composition and parameters that may be used for capturing the suggested image enclosure. The received suggestion may be analyzed and combined with the input wide-view image to generate the image to be captured using the parameters provided by the suggestion.

In various embodiments, the offline photography learning module 236 may mine composition and exposure rules. In the offline photography learning module 236, view cluster discovering is performed in a scope of geo-locations by clustering based on both image visual features and their scene context. Because some view clusters are more appealing than others, view cluster ranking is then carried out. The view cluster ranking results may be utilized to make the searching process more efficient. In some embodiments, composition learning may be performed for each view cluster discovered. Moreover, due to the fact that professional photographers usually adjust the camera exposure parameters according to the brightness and color of the objects and the whole settings, as well as the lighting condition influenced by a variety of factors, such as the intensity and the direction of sunshine which are affected by the season and the time of the day as well as weather conditions, metric learning of exposure feature space for aperture, ISO, exposure time, exposure compensation or exposure value may be carried out to model the various effects of content and context to the exposure parameters.

In the online photography suggestion module 238, parameters and/or image view enclosures may be provided as suggestions. In some embodiments, utilizing the visual content and scene context of the input, relevant view clusters similar to all possible view enclosure candidates of the input image may be found. Because some view enclosure candidates are not desirable no matter how much tuning is performed, view enclosure candidates similar to the low ranked view clusters are discarded. One or more optimal view enclosures may be selected based on the offline learned view specific composition principles from the remaining enclosure candidates. Once the mobile device is provided with the one or more view enclosures, the appropriate exposure parameters, e.g., exposure time, aperture and ISO suitable for the view and lighting conditions may be suggested.

The mobile device 110 may include a communication interface 240, a user interface 250, and a camera module 260. The communication interface 240 may include wireless and/or wireless communication interface components that enable the mobile device 110 to transmit and receive data via a network or a communication link. In various embodiments, the wireless interface component may include, but is not limited to cellular, Wi-Fi, Ultra-wideband (UWB), Bluetooth, and/or so forth. The wired interface component may include a direct input/output (I/O) interface, such as an Ethernet interface, a serial interface, a Universal Serial Bus (USB) interface, and/or so forth. As such, the communication interface 240 may enable the camera module 260 to exchange data with the computing device(s) 202.

The user interface 250 may include a data output device (e.g., visual display, audio speakers), and one or more data input devices. The data input devices may include, but are not limited to, combinations of one or more of keypads, keyboards, mouse devices, display screens, touch screens that accept gestures, microphones, voice or speech recognition devices, and any other suitable devices or other electronic/software selection methods. The user 106 may use the user interface 250 to interact with the camera module 260 for taking images, videos or the like. For example, the user interface 250 may be used to control the parameters of the image for the camera modules 260. In some embodiment, the user interface 250 may allow a user to select the suggestions received from the suggestion communications module 234. In some embodiments, the user interface 250 may provide the user a means to determine, select or modify the view enclosure. In another example, the user interface 250 may be used to provide user inputs to the input device(s) 208 of the computing device(s) 202.

The camera module 260 may include software and/or hardware to assist in taking an image for the user 106. For example, the camera module 260 may allow the mobile device to operate to take images. The camera module 260 may include software that emulates a camera using the mobile device.

### Example Processes

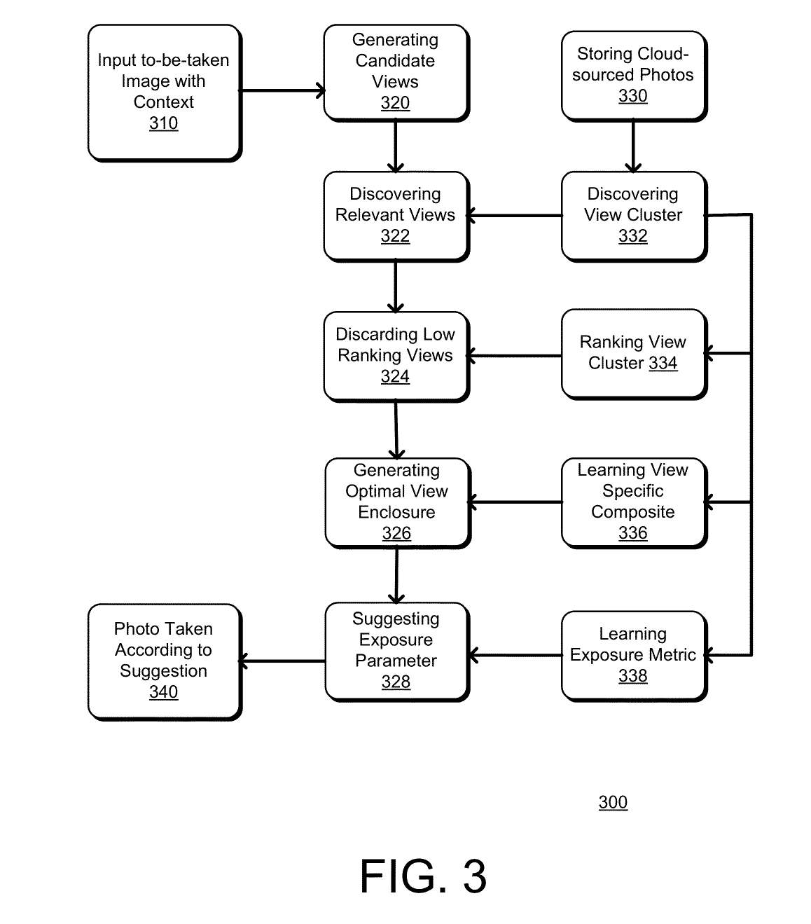

FIG. 3 is a flow diagram of an example process for socialized mobile photography, in accordance with various embodiments. The process 300 is illustrated as a collection of blocks in a logical flow graph, which represents a sequence of operations that may be implemented in hardware, processor-executable instructions (software or firmware), or a combination thereof. In the context of software, the blocks represent computer-executable instructions that, when executed by one or more processor(s) 204, cause the one or more processors to perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. Further, these operations may, but need not necessarily, be implemented using the arrangement of FIGS. 1-2. Consequently, by way of explanation, and not limitation, the method is described in the context of FIGS. 1-2. Other processes described throughout this disclosure, including the processes 400 and 500, in addition to process 300, shall be interpreted accordingly.

In various embodiments, the process 300 performs operations for socialized mobile photography, in accordance with various embodiments. At 310, an image and context associated with the image may be received. This information may be received by a mobile device. In some embodiments, the input may be obtained by a person attempting to take a photograph of a scene using a mobile phone. In other embodiments, this input may be obtained using a digital camera. Any process and/or equipment to receive the input may be used.

At 330, aggregated images are stored locally or remotely assessable via the internet. When photographers visit a location, they tend to capture images from a certain number of photo-worthy viewpoints. The images taken in and around the location with their social context information such as number of views may provide insight to the aesthetics and composition rules of different viewpoints.

At 332, a content and geo-location based clustering process may be carried out to discover one or more view clusters in the location scope. As the images within the same view cluster may contain the same main objects, local feature with geometric verification may be used to capture image content similarity. To facilitate the clustering and the online relevant view discovering process, the crowd-sourced images in the location scope may be indexed by inverted files based on scale-invariant feature transform (SIFT) visual words. To overcome the false matching caused by the ambiguity of the visual words, geometric relationships among the visual words may also recorded into the index by spatial coding. Hence, using the index, the image content similarity may be efficiently computed based on the matching score formulated by the number of matched visual words passing the spatial verification. In addition, considering images captured from closed places usually have similar content from similar perspectives, location may be also adopted to the view cluster discovering process. The image location similarity may be calculated based on their GPS Euclidean distance. Then the view clusters may be discovered by a clustering process based on image similarity obtained by fusion of their content similarity and location similarity. The similarity fusion is achieved using their product.

In some embodiments, affinity propagation, which does not require the specification of number of clusters, may be performed to cluster the images into different views based on the fused image similarity.

In some embodiment, relevant rules for each cluster may be modeled to learn the photography rules of a given content from a certain perspective. However, the noisy images without the main objects in the view clusters discovered by the above clustering process may negatively affect the photography learning process. It may be necessary to denoise the images without the same content. To identify the images sharing the main objects with other images in the cluster, one or more objects may be defined as the iconic image based on local features. In some embodiments, image or object with maximum total content similarity scores with the others within the cluster are chosen as the iconic image of the view cluster. Afterwards, the images or objects with content similarity score less than the threshold T_{c}=4 are considered noisy images without the main objects in the cluster and thus are discarded. Then, noisy clusters without representative content in the scene such as the ones containing portraits and crowds may be removed by discarding the clusters with quite a small number of images.

At 334, the cluster size and score distribution of the images in the cluster may be used to rank the view clusters. In some embodiments, a score may be generated based on information obtained from associated websites. For example, the average score AS(k) of cluster k may be determined by

$$AS ( k ) = \frac{{\sum }_{{r}_{k} = 1}^{{n}_{k}} P ( {r}_{k} )}{{n}_{k}} , \\ P ( {r}_{k} ) = \frac{{\sum }_{{i}_{k}}^{{r}_{k}} {s}_{{i}_{k}}}{{\sum }_{j = 1}^{{r}_{k}} {s}_{j}} ,$$

where nₖ is the number of images in the view cluster. rₖ is the r-th image belonging to cluster k in the whole rank list. P(rₖ) is the ratio of the total score of images within the cluster k to the total score of images at the cut-off rank of image rₖ in the whole rank list, in which sᵢ_{ₖ} is the i-th image belonging to cluster k and sⱼ is the j-th image in the rank list no matter which cluster it belongs to. In addition, the appealing degree of the view cluster can also be reflected by the size of the cluster, since pleasing objects tend to draw more photographers' attention and hence a large number of images are aggregated in the view cluster. Therefore, the view clusters are ranked according to the scores calculated by VS(k)=AS(k)·(1−e⁻ⁿ^{ₖ}). In some embodiments, the larger the view cluster size, the higher the view is scored.

In various embodiments, an image aesthetic score may be generated for ranking of the view cluster. In some social media websites, photos may be rated by a number of professional photographers, the ratings may reflect the photo aesthetics. Other context information may also be used. In some embodiments, the image aesthetic scores may be generated based on several heuristic criterions, e.g., ranking of interestingness, number of favorites, number of views.

In some embodiments, an interestingness-enabled search may be provided by an Internet photo website's application interface (API). This search may results in the interestingness ranking. The interestingness rankings may be determined based on the quantity of user entered metadata such as tags, comments and annotations, the number of users who assigned metadata, user access patterns, and a lapse of time of the media objects. In some embodiments, to accurately consider older photos, the interestingness has subsumed the number of views and the number of favorites because older photos usually have high quantity in these two terms. The number of favorites may show how many people have liked the image. Hence, it is a straightforward reflection of the photo's degree of appeal. In some embodiment, high quality images may be viewed by more users, which may be used in aesthetic score generation to complement the number of favorites.

Therefore, by weakening the time fading effect of interestingness rankings via highlighting the impacts from number of views and favorites, interestingness rankings are utilized to generate photo aesthetic scores by fusing the above three factors as follows: Sᵢ=100·(1−e^{-(av}^{ᵢ}^{+βf}^{ᵢ}⁾)·e^{-R}^{ᵢ}^{/N}, where vᵢ and fᵢ are the number of views and number of favorites of image i, respectively. Rᵢ is the rank of image i based on interestingness. N is the total number of crawled images in the location scope. In this way, the aesthetic scores ranged from 0 to 100 are generated, in which high quality photos are assigned with high aesthetic scores. Through empirical analysis, In some embodiments, α=0.2 and β=1.

At 336, learning view specific composition is performed. The view specific composition learning may be performed to extract different composition principles for each view cluster. The images of each cluster usually contain the same objects from similar perspectives but with different positions and scales in the frame. The difference is one key factor leading to the different aesthetical scores. To characterize the composition difference in terms of the main object placement for each cluster, the camera operations compared with the cluster iconic image are utilized to represent the main object composition. The camera operation is defined as horizontal translation, vertical translation, zoom in/out, and rotation. Using the matched SIFT points, the coordinates in the given image I (Iₓ, I_{y})^{T} may be represented by the affine model based on the coordinates of its corresponding matched points in the cluster iconic image (Cₓ, C_{y})^{T} as follows:

$$( \begin{matrix}{I}_{x} \\ {I}_{y}\end{matrix} ) = ( \begin{matrix}{a}_{2} & {a}_{3} \\ {a}_{5} & {a}_{6}\end{matrix} ) ( \begin{matrix}{C}_{x} \\ {C}_{y}\end{matrix} ) + ( \begin{matrix}{a}_{1} \\ {a}_{4}\end{matrix} ) .$$

The parameters of the affine model φ=(a₁, a₂, a₃, a₄, a₅, a₆) may be calculated by the least square method based on all matched SIFT points in the given image. Based on the affine parameters, the camera operations φ′ can be obtained by φ′=(pan, tilt, zoom, rotation)

$$where \{ \begin{matrix}pan = {a}_{1} , tilt = {a}_{4} \\ zoom = \frac{1}{2} ( {a}_{2} + {a}_{6} ) \\ rotation = \frac{1}{2} ( {a}_{5} - {a}_{3} )\end{matrix} .$$

The terms of the camera operations φ′, pan, tilt, zoom and rotation represent the camera horizontal translation, vertical translation, zoom in/out degree, and rotation, respectively. In some embodiments, the object composition in terms of scale and location may be captured by the camera operations compared with the view cluster iconic image.

In some embodiments, salient objects in the photos may also affect the image compositions. Therefore, the spatial distribution of saliency is also utilized to capture the composition. For example, the image may be divided into a grid, e.g., 5×5 grid, the average saliency value in each grid may be calculated to form the vector to represent the saliency spatial distribution. The saliency map is computed by a spectral residual approach. In an embodiment, the camera operation vector and the saliency spatial distribution are concatenated together to capture the image composition. In some embodiments, when computing the composition features, the images may be normalized to the same size, e.g., 640×426 or 426×640 for vertical and horizontal images respectively, since medium version images crawled from Flickr and other similar web sites has aspect ratio of 3:2 or 2:3, and the larger side may be 640 pixels. In some embodiments, the composition models of horizontal image and vertical images may be learned separately, since they may follow different composition rules when camera orientations are different, though the objects and perspectives are the same.

In various embodiments, the composition rules may be learned for view cluster k, as a two class classification problem using RBF kernel based Support Vector Machine (SVM) classifier. Any margins may be used to avoid ambiguity of the photo quality falling into the margin. For example, the margin may be set as 5*2=10. In this example, the images of cluster k with aesthetic score higher than Mₖ+5 and the ones with score lower than Mₖ−5 are considered as high quality and low quality images, respectively, where Mₖ is the median value of the aesthetic scores in cluster k. The images with score between Mₖ−5 and Mₖ+5 are not utilized in the training process to overcome the quality ambiguity issue. The SVM classifier training leads to the learned hyperplane which is able to separate the photos with good and bad compositions in cluster k. Afterwards, the image aesthetic score Sᵢ can be inferred by the rescaled sigmoid function based on the distance dₖ (i) from the hyperplane to the given image i by

$${S}_{i} = \frac{100}{1 + {e}^{- {d}_{k} ( i )}} .$$

As the distance goes from 0 to the negative infinity, the aesthetic score decreases from 50 to 0, while as the distance goes from 0 to the positive infinity, the aesthetic score goes from 50 to 100. In some embodiment, cross validation may be employed to search for their corresponding optimal parameters error parameter C, tube-width ε and kernel parameter σ. In some embodiment, the composition rules can be learned by various regression methods.

At 338, learning exposure metric is performed. In various embodiments, the exposure parameters may be determined by jointly considering the shooting content and various lighting related contexts. Different hues and/or colors may be assigned with different light values. As the images in the same view clusters usually contain the same objects from similar capture angle, a cluster id may be used to represent the shooting content feature. Moreover, a series of features may be extracted to obtain the contextual information related to the lighting conditions. In some embodiments, temporal and weather contextual features may be obtained or inferred. Some temporal feature may include time-of-day, month, and weather condition information.

In some embodiments, time-of-day information may be used. The sunshine direction and luminance may vary with the time-of-day. For example, two images with the same shooting content captured at the sunrise time and at noon may have different exposure parameter settings to fit the lighting difference. In some embodiments, the variation of sunrise and sunset time may be considered and the time period of the day may be placed into any number of bins as desired. For example, one way includes splitting the time period of the day into six bins: [sunrise time−1 hr, sunrise time+1 hr), [sunrise time+1 hr, 11 am), [11 am, 2 pm), [2 pm, sunset time−1 hr), [sunset time−1 hr, sunset time+1 hr), and [sunset+1 hr, sunrise time of the next day−1 hr). The sunrise and sunset time of every day in the given location may be obtained from any weather record websites. In some embodiments, the historical sunrise and sunset time may be obtained by specifying the geo-location and date for the crowd-sourced photos.

In some embodiment, month or season information may be used. The light intensity changes with the season for a given geo-location. Month information may be used. For example, the light intensity at noon is likely to be stronger in summer than that in winter.

In some embodiment, weather condition information may be used. The weather conditions influences the lighting. For example, the light is likely to be stronger in sunny days than that of cloudy days, which also directly affect the exposures. Values of the weather condition may be defined as: clear, cloudy, flurries, fog, overcast, rain, and snow. Any desired values may be defined to improve the appearance of the image. The historical hourly weather information may be obtained from any source that includes the date, time and geo-location. In some embodiment, the dataset may be built by GPS enabled search since the images are tagged with their GPS information. In addition, the date and time may be found from the EXIF of photos.

In various embodiments, the exposure parameters may be modeled by supervised distance metric learning. The exposure parameters may be used for a transformation of the feature space to maximize the classification performance. The transformation of the exposure feature space provides the ability to rescale the dimensions of the feature space. The transformation may project the images with similar exposure parameters into clusters.

To perform distance metric learning for the exposure feature space, Large Margin Nearest Neighbor (LMNN), a distance metric learner designed for k-nearest neighbor (kNN) classifier, may be utilized to maintain that the k-nearest neighbors belong to the same class while the samples from different classes are separated by a large margin. In some embodiment, the distance metric learning maximizes the kNN classification performance without the unimodal distribution assumption for each class. For example, the exposure parameters for the same view cluster under similar weather conditions at sunrise and sunset may be the same, but fall into different clusters after exposure feature space transformation. In learning exposure metric 338, the exposure parameters of the photos are represented in the exposure feature space with their exposure parameter values as labels.

In various embodiments, the metrics for the parameters is learned separately because different exposure parameters have different sensitivity and functionality to the content and context dimensions. For example, at night, photographers tend to increase the ISO values to overcome the issue of weak lighting, while besides the concerns about lighting, they tend to use large aperture to reduce the depth of field when shooting single objects. In some embodiment, the exposure feature space distance metrics may be modeled for aperture, ISO and exposure time (ET), directly. Then, the exposure value can be calculated by

$$EV = {log}_{2} \frac{100 \cdot {Aperture}^{2}}{ISO \cdot ET} ,$$

where EV and ET are exposure value and exposure time, respectively.

In various embodiments, exposure compensation (EC) may be used to achieve the desired EV by learning the distance metrics of the exposure feature space for EC. Similarly, metric learning of exposure feature space for aperture and ISO are also performed, respectively. Once the desired EV, aperture and ISO are obtained, ET may be calculated.

In some embodiments, given the input image, with the view specific composition model and the exposure parameter metrics, the desired view and proper camera parameters may be suggested. Once the input image and the associated scene context is provided (e.g, sent to the cloud server), one or more SIFT features and saliency features may be generated. Later on, the view enclosure candidates may be generated by sliding windows and their features can be obtained quickly by simply cutting out from the original image features. Then, with the indices of the images in the location, the most relevant images of the candidates can be retrieved and thus their view clusters can be found in a parallel fashion. Due to the limited number of view clusters, the highest ranked relevant cluster can be obtained quickly. The aesthetic scores of the candidates belonging to the highest ranked relevant cluster are predicted in parallel with the offline learned composition model. Since the current weather information can be prefetched for the given location, the offline learned exposure parameter metrics can be employed to obtain suitable parameters with a simple operation.

At 320, candidate views of the image may be generated. In some embodiments, the image from the input to be taken with context may include an input wide-view image I with size W_{I}×H_{I}. View candidates at various positions in different scales may be generated for view selection. In some embodiments, a window of the given aspect ratio with moving step size

$${S}_{m} = 64 from \frac{{W}_{I}}{3} \times \frac{{W}_{I}}{2} or \frac{{H}_{I}}{2} \times \frac{{H}_{I}}{3}$$

for horizontal and vertical input image, respectively, may be varied until the largest possible window size with a scaling ratio. In some embodiments, the scaling ratio may be r=1.2. Any ratio may be used to generate possible view enclosure candidates.

At 322, once the view candidates are generated, their relevant view clusters containing the same content have to be discovered for their composition aesthetics judgment. In some embodiments, the image index may be used for discovering relevant views. In other embodiments, the image index may be built offline. In various embodiments, the most relevant image may be retrieved for each of the view candidates. In various embodiments, the view cluster of 332, which the relevant image belongs to, may be used as the relevant view cluster of the view candidates. In some embodiments, the visual words extraction may be performed at least once on the input image and the visual words of each view candidate may be obtained based on an enclosure coordinates.

At 324, a number of view enclosure candidates may be discarded based on view cluster rankings. In some embodiment, the ranking of the relevant view cluster determines which objects to capture to make the photo more appealing. In addition, a pre-processing step may be used to make the view searching run efficiently. Once the relevant view cluster with similar content is found for each of the view enclosure candidates, the view cluster rankings already obtained may be used to search through the candidates belonging to the highest ranked view cluster out of all relevant clusters. Then, the view enclosure candidates belonging to relatively low ranked view clusters may be discarded.

At 326, optimal view searching may be performed through the remaining candidates belonging to the top ranked relevant cluster. For the view candidates relevant to the same view cluster, they contain similar objects with slight variance on the arrangement and scale. To make a view suggestion, the candidate with highest predicted aesthetic scores is considered as optimal view enclosure. Therefore, the aesthetic scores of the remaining candidates belonging to the top ranked relevant cluster may be predicted using the learned view specific composition rules and may suggest the most highly ranked one to mobile users.

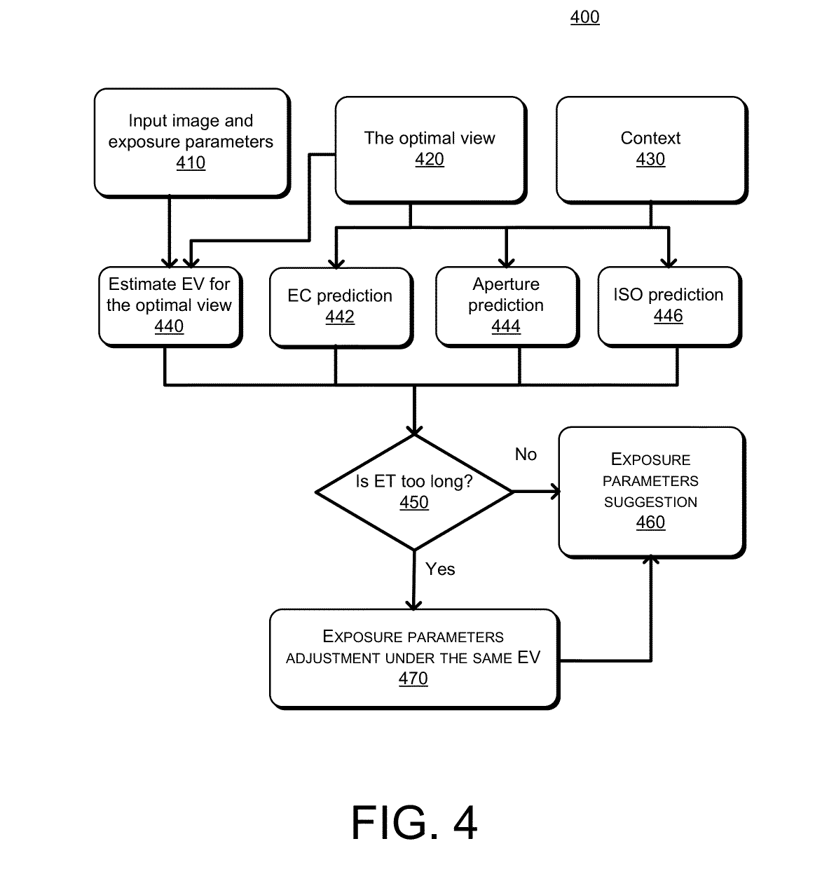

At 328, exposure parameter may be suggested. The suggestion may be determined by using the transformed exposure feature space to predict exposure parameters. In some embodiments, the exposure parameter suggestions may be performed as shown in FIG. 4.

FIG. 4 is a flow diagram of an example process for exposure parameter suggestion, in accordance with various embodiments. Once the input image and exposure parameters 410 and optimal view enclosure 420 is obtained, the optimal EV fitting the view and context is estimated 440. To sufficiently take advantage of the camera light metering results of the input image and avoid the inconvenience of asking mobile users to manually capture the suggested view, the EV of the suggested view enclosure from the camera meter may be estimated as follows:

$${EV}_{view} = {EV}_{input} + {log}_{2} [ {( \frac{{M}_{view}}{{M}_{input}} )}^{γ} ] ,$$

where EV_{view} and EVᵢₙₚᵤₜ are the estimated EV of the suggested view enclosure and the input panoramic image from the camera meter, respectively. M_{view} and Mᵢₙₚᵤₜ are the median intensity of the suggested view enclosure and the input panoramic image, respectively. In some embodiments, γ may be set as 2.2.

Utilizing the suggested view content and context 430, in 442, EC may be predicted and thus the correct EV for the suggested view enclosure EVₒₚₜ may be calculated by EVₒₚₜ=EV_{view}+EC_{view}, where EC_{view} is the predicted EC for the suggested view. In 444 and 446, with the view content and context 430, the corresponding aperture and ISO may also be predicted based on their learned metrics, respectively.

One problem with exposure parameter prediction is the possible confliction of the diverse capabilities of mobile cameras and the camera parameters of the crawled image taken by some professional cameras. For example, the predicted aperture f/2.4 may not be supported by some mobile devices. Therefore, in that case, all the training samples of the previous predicted label are temporarily removed to predict the next optimal parameter until it is allowed by the current camera capabilities.

Once getting the correct EV, aperture and ISO, the corresponding ET may be calculated as described above. At that time, if the ET is larger than the threshold T_{ET} 450, then the image taken would probably be blurred due to hand jittering. If it is smaller than T_{ET}, then the aperture, ISO and ET are suggested 460; otherwise the exposure parameters have to be adjusted under the same EV 470.

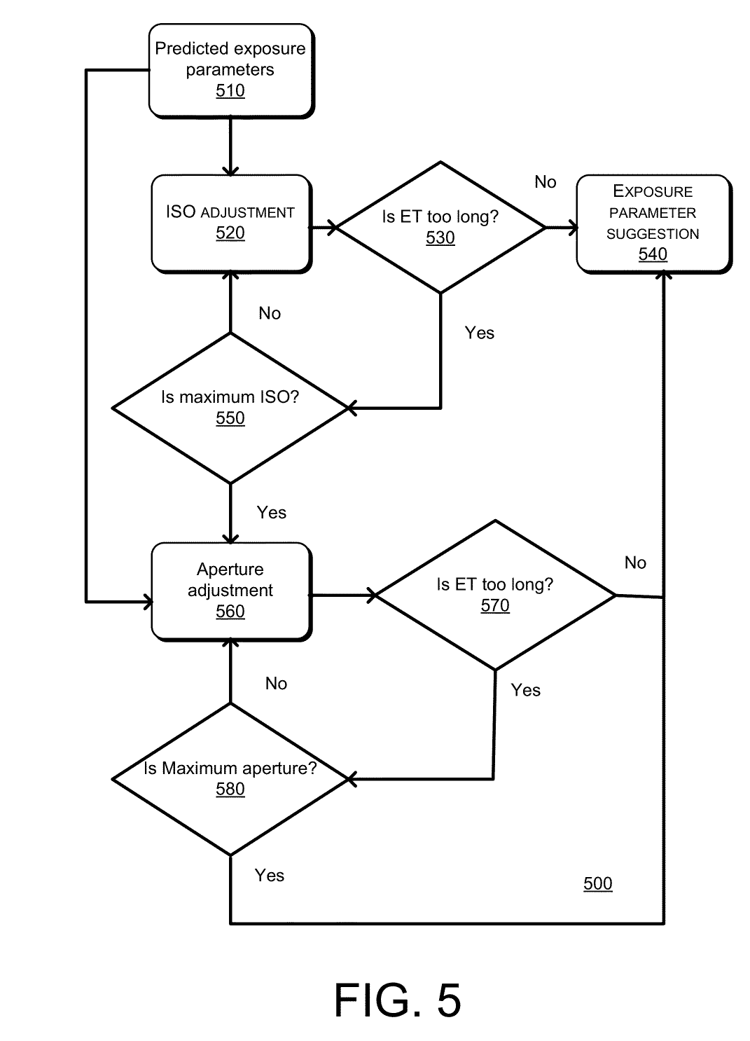

FIG. 5 is a flow diagram of an example process for exposure parameter adjustment 500, in accordance with various embodiments. In various embodiments, the initial predicted exposure parameter set is provided 510. Then the ISO and aperture may be adjusted based on the set. In 520, adjustment of the predicted ISO value in the current camera may be performed on allowable ISO settings, in which ISO is the current ISO value, ISO_{update} is the updated ISO value. ISO_{update}=2·ISO.

Hence, ET can be reduced while maintaining the same EV. Then, if ET is below T_{ET} 530, the parameter adjustment stop and the updated parameter set is suggested 540; otherwise, further adjustment is needed. When updating the ISO value, the current camera allowable range of ISO values may be checked. If the maximum ISO has not been reached then ISO is adjusted accordingly. Once the maximum ISO value is reached 550, the ET may be decreased by decreasing the aperture value at 560 using

$${Aperture}_{update} = \frac{Aperture}{1.4} .$$

Similarly, when updating aperture at 560, the updated aperture has to be supported by the current camera. Hence, the optimal set of exposure parameters fitting the suggested view and lighting contexts considering the mobile camera capabilities may be obtained. In some embodiment, whether ET is too long is determined at 570. If ET is below T_{ET}, the parameter adjustment stop and the updated parameter set is suggested at 540; otherwise, whether maximum aperture adjustment is checked at 580. If maximum has not reached, then aperture is adjusted at 560; else the parameter adjustment stops and the updated parameter set is suggested at 540.

Returning to FIG. 3, the exposure parameter may be provided to the user and/or the mobile device. The exposure parameter may be used to capture the image according to the suggested parameter 340; thereby taking the photo with learned composition rules and exposure principles from the crowd-sourced photos.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving from a mobile device an image to be captured by the mobile device and corresponding scene context;
analyzing a set of images;
performing crowd-sourced learning using a social context and the scene context associated with the set of images as well as content of the set of images; and
determining a composition suggestion and parameter suggestion for the image based at least in part on the content, the scene context and the social context.

2. The method of claim 1, wherein the image comprises a scene being captured with the mobile device.

3. The method of claim 2, wherein the mobile device comprises at least one of a cellular phone, tablet computer, or a digital camera.

4. The method of claim 1 further comprises transmitting the composition suggestion and parameter suggestion to the mobile device.

5. The method of claim 1, wherein the receiving from the mobile device comprises receiving multiple consecutive images to be synthesized into a panorama image.

6. The method of claim 1, wherein the performing the crowd-sourced learning comprises ranking the view cluster and learning an exposure metric, wherein the exposure metric is based at least in part on a lighting condition.

7. The method of claim 1, wherein the parameter suggestion is determined online while the image is being captured.

8. The method of claim 1, wherein the determining the composition suggestion comprises generating a view enclosure based at least in part on one or more candidate views.

9. The method of claim 1 further comprising adjusting one or more values of the parameter suggestion.

10. A system comprising:
one or more processors;
a memory, accessible by the one or more processors;
an input image module stored in the memory and executable on the one or more processors to receive an image and associated context information;
a learning module stored in the memory and executable on the one or more processors to mine composition and exposure rules;
a suggestion module stored in the memory and executable on the one or more processors to determine and provide a composition suggestion and a parameter suggestion; and
a transmitting module stored in the memory and executable on the one or more processors to provide the composition suggestion and parameter suggestion to aid in the capturing of the image.

11. The system of claim 10, wherein the associated context information includes at least one of geo-location information, time-of-day, weather, exposure time, aperture, and ISO information.

12. The system of claim 10, wherein the learning module uses content, scene context and social context.

13. The system of claim 12 wherein the social context includes at least one of number of view, number of favorites, tag information, comments and explicit ratings.

14. The system of claim 10, wherein the suggestion module determines a view enclosure associated with composition suggestion and a value associated with the parameter suggestion.

15. The system of claim 14, wherein the value includes at least one of ISO, Aperture, and exposure time.

16. A computer-readable storage device storing a plurality of executable instructions configured to program a computing device to perform operations comprising:
receiving an image and corresponding scene context;
analyzing a set of photographs;
performing crowd-sourced learning using a social context and scene context associated with the set of photographs; and
determining a composition suggestion and parameter suggestion for the image based at least in part on the scene context and the social context.

17. The device of claim 16, wherein the operations further comprise capturing the image according to the composition suggestion and the parameter suggestion.

18. The device of claim 16, wherein the performing the crowd-sourced learning comprises ranking the view cluster and learning an exposure metric.

19. The device of claim 16, wherein the operations further comprising adjusting a view enclosure and adjusting one or more values of the parameter suggestion.

20. The device of claim 16, wherein the determining the composition suggestion and the parameter suggestion comprises generating a view enclosure.
